(19) United States
(12) Patent Application Publication
(10) Pub. No.: US 2005/0156556 A1
(43) Pub. Date: Jul. 21, 2005

(54) VARIABLE SPEED CONTROL STALL DETECTION AND RESPONSE SYSTEM

(75) Inventors: Tamas Hermann, Millarville (CA); Curtis Bennett, Calgary (CA)

Correspondence Address: SEAN W. GOODWIN, 237- 8TH AVE. S.E., SUITE 360, THE BURNS BUILDING, CALGARY, AB, T2G 5C3, CA

(73) Assignee: HBX CONTROL SYSTEMS INC., Calgary (CA)

(21) Appl. No.: 10/905,829

(22) Filed: Jan. 21, 2005

(30) Foreign Application Priority Data
Jan. 21, 2004 (CA) 2,455,545

(51) Int. Cl. H02P 1/26

(52) U.S. Cl. 318/778

(57) ABSTRACT

A variable frequency drive for an AC induction motor includes a stall sensing system coupled with a voltage frequency response system. Upon sensing a rise in the current which suggests a stall, and before triggering a motor shutdown, the VFD is caused to increase the V/f ratio to the motor and thereby induce a high-torque shaking response and seek to overcome any mechanically induced stall. The motor can be cycled between a first V/f ratio and a second V/f ratio in several attempts to release the stall.

### FIELD OF THE INVENTION

The present invention relates to variable speed drives and control systems for AC motors such as those using AC-to-DC to variable frequency AC output for speed control. More particularly, a stall detection and response system is provided which can be applied in applications such as motor-driven pumps.

### BACKGROUND OF THE INVENTION

AC motors driven using conventional variable speed drives can occasionally stall, resulting in large electrical current. Conventional controls typically provide stall protection which shut down the drive and motor.

Instances in which a motor may be stalled include motors coupled to devices such as pumps and where the pump may be in the process of being restarted after a long period of inactivity. Deposits in the pump can temporarily seize the pump. Ordinary application of starting motor torque to such a seized pump is not generally a successful tactic to release the pump. Hence, a stalled motor would result in high amperage and for the safety of the motor, it would require being shut down.

Preferably, the device would be released in some manner. For production purposes, it may not always be in the best interests of either the operation or the device to be required to stop the motor.

Others have tried to release a stall situation, such as in a stalled pump situation, by implementing a cyclical on-off response, however this alternating application of conventional starting torque is often insufficient to deal with many stall issues.

### SUMMARY OF THE INVENTION

In an embodiment of the invention, a motor normally coupled to rotate a driven device is temporarily caused to operate in a manner which imparts mechanical energy into the device when the motor stalls, such as in instances when the device ceases to rotate. A variable speed drive (VFD) is provided. The motor load or current is monitored. Upon sensing a rise in the current which suggests a stall, and before triggering a motor shutdown, a novel stall detection and response system implements a high-torque shaking response through tuning of the drive frequency and voltage in an attempt to release a jammed or locked device coupled to the motor. For instance, the motor is may be coupled to a pump which may have encountered an obstruction or is seized from a period of inactivity and deposits therein. Similarly, other mechanical drive situations can be envisioned wherein a shaking may remove the non-rotational condition.

Contrary to the conventional practice of reducing voltage upon applying decreasing frequencies while reducing rotational speed, Applicant increases the ratio of voltage over frequency (V/f) for inducing shaking.

In a broad aspect, the system adjusts one or both the frequency and the drive voltage to increase the V/f ratio and thereby induce a high-torque shaking. The maximum ratio applied is limited by the maximum safe drive current. After a pre-determined number of unsuccessful attempts to release the motor, an alarm and a motor shutdown occurs. Alternatively, the stall condition can be monitored to avoid excess shaking sequences.

Apparatus is provided for overcoming a mechanically induced stall in a device rotationally coupled to an AC induction motor comprising: a variable frequency drive (VFD) for outputting voltage (V) and frequency (f) to the motor at a first V/f ratio for normal operation of the motor and coupled device; a stall detection system for sensing motor current and establishing a stall situation; and a response system for adjusting the V and f output from the VFD to the motor to at least a second V/f ratio which is greater than the first V/f ratio, wherein upon detecting a stall situation, the at least second V/f ratio induces shaking in the motor therein for overcoming the mechanically induced stall.

A method for operation of the apparatus comprises: outputting voltage (V) and frequency (f) to the motor at a first V/f ratio for normal operation of the motor and coupled device; sensing motor current for establishing a stall situation; and adjusting the V and f output to the motor to at least a second V/f ratio which is greater than the first ratio to induce shaking in the motor therein for overcoming the mechanically induced stall.

Preferably, after inducing shaking for a pre-determined period of time, further comprising: adjusting V and f output to about the first V/f ratio, being less than the at least second V/f ratio; sensing motor current for establishing whether the stall situation has been overcome; and repeating the steps of adjusting the V and f output between the second V/f ratio and the first V/f ratio for overcoming the mechanically induced stall.

### BRIEF DESCRIPTION OF THE DRAWINGS

FIG. 1 is a schematic of a VFD, a motor and a driven device according to one embodiment of the invention;

FIG. 2a is a diagrammatic case of a motor driving a device such as a pump in normal operation and at a conventional full speed V/f of 2;

FIG. 2b is a diagrammatic case of the motor of FIG. 2a attempting to drive a stalled device, with corrective shaking operation initiated with a V/f of 5;

FIG. 2c is a diagrammatic case of the a motor of FIG. 2b after shaking in which the stall is overcome and the pump resumes normal operation at a nominal V/f of 2;

FIG. 3 is a graph illustrating multiple shaking events to attempt to release a motor and coupled device before finally terminating, following three unsuccessful attempts; and

FIG. 4 is a flow chart illustrating the sequence of detecting a stall and correcting the stall with the shaking operation.

### DESCRIPTION OF THE PREFERRED EMBODIMENTS

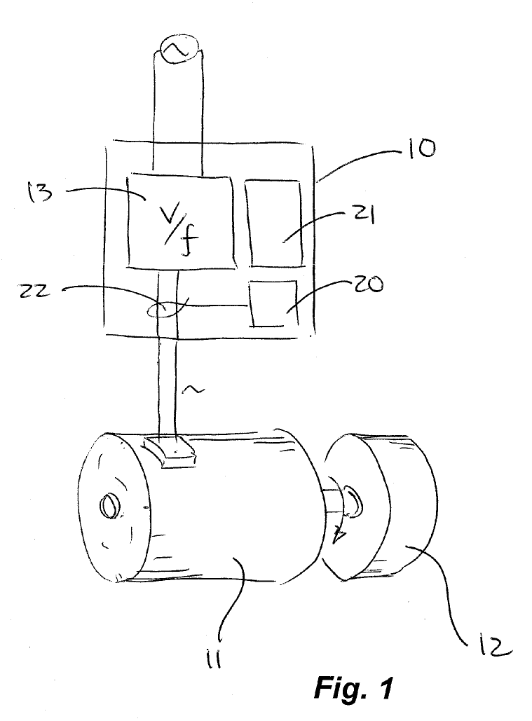

With reference to FIG. 1, in one embodiment, a conventional variable frequency drive (VFD) 10 is provided to adjust the voltage and frequency to an AC induction motor 11 for driving a device 12. The VFD 10 is a controller for converting AC current input to DC and DC to variable frequency AC current output for speed control of an AC induction motor.

The VFD 10 can be conventional in many aspects. However, typical control circuitry 13 for controlling voltage V and frequency f is modified or custom circuitry is provided to include a stall monitoring system 20 and a response system 21. The embodiments are described herein in the context of a device 12 such as a pump although other driven devices and drive situations are intended to be included in the scope of the invention.

The stall monitoring system 20 monitors the current to the motor 11, typically through a load resistor 22. The specifications for the motor are determined and a maximum current threshold is pre-determined. The current threshold can be a function related to the torque and speed curves for the particular motor 11. For instance, the current threshold would be lower at lower frequency and thus lower speed. A motor-specific threshold current is set and operational currents in excess of that threshold current indicate a stall for that motor 11.

When a stall is sensed, in which case the current threshold could be over 1.5 times the normal operating current for that rotational speed, the response system 21 initiates a high-torque shaking sequence.

When a stall is detected, the torque for the motor 11 is increased beyond its normal torque specification through increasing the ratio of VFD voltage and frequency (V/f) output to the motor 11.

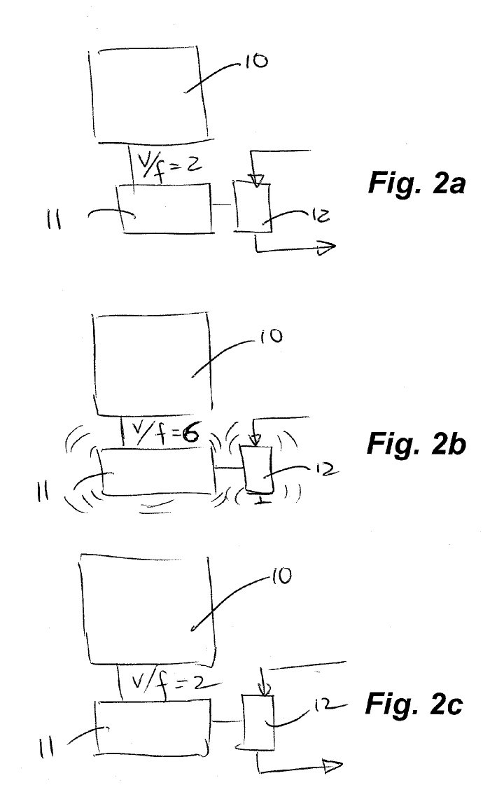

With reference as well to FIGS. 2a-2c, and turning to FIG. 2a, for normal operation, a single phase AC induction motor 11 may have a first ratio V/f of about 110V/60 Hz or about 2, at full rotational speed. Similarly, the same motor may normally operate at 2 rotational speed at 85V/30 Hz for a first ratio V/f of about 2.8. As shown fancifully in FIG. 2b, to induce shaking, the V/f ratio is raised by lowering the frequency significantly or raising the voltage, or both. As stated, the voltage could be raised or lowered, but regardless, the aforementioned V/f ratio is increased to at least a second ratio. For instance, in usual cases of normal full rotational speed operations the frequency might be adjusted downward to about 20 Hz to induce shaking and preferably not lower than 15 Hz to obtain a second V/f ratio of about 6. This elevated V/f ratio generates high torque and shaking of the motor 11 and coupled device 12. Due to resulting high currents, the shaking is only conducted for a short period of time. The maximum extent of the increase in the second V/f ratio is set by the maximum current which can be applied to the motor 11. This information is available from each motor manufacturer. The current can be monitored to avoid exceeding safe threshold levels. After shaking, the V/f ratio is returned to about pre-shaking levels, about the first V/f ratio, ideally to resume normal operations as shown in FIG. 2c.

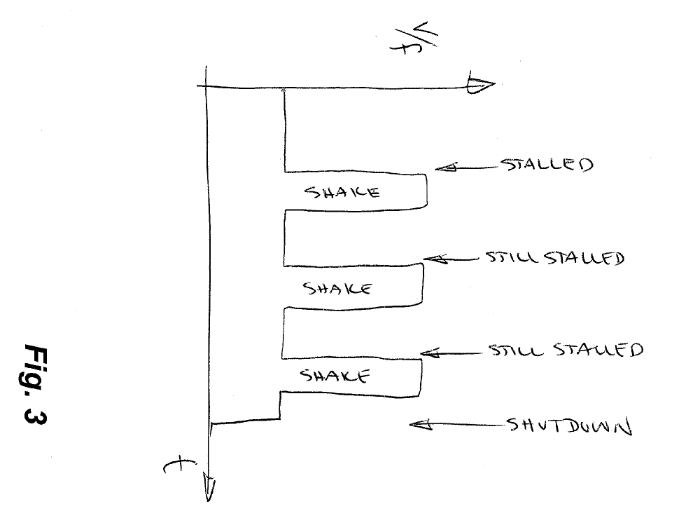

With reference to FIG. 3, the cycling of the V/f, between normal first V/f ratios, substantially according to manufacturer specifications and greater shaking second V/f ratios, can be repeated several times as necessary to attempt to clear obstructions or release a stalled device 12 and motor 11.

Under certain conditions, the VFD 10 is normally set to lower frequencies to control the motor at lower speeds. Voltage V and frequency f are normally varied at a constant ratio V/f (all of which are deemed to be first ratios) up to the base rotational speed. The motor 11 is more sensitive to frequency change and thus it may be preferable to raise the V/f ratio sequentially; in one example one may initially raise the voltage and then lower the frequency. One might even initially raise the frequency somewhat or not lower the frequency as much as one might similarly do at full speed conditions. Similarly, by initially raising the voltage before lowering the frequency, one may avoid an overly high current scenario. Regardless, the net effect is that the V/F ratio is increased and the torque increases.

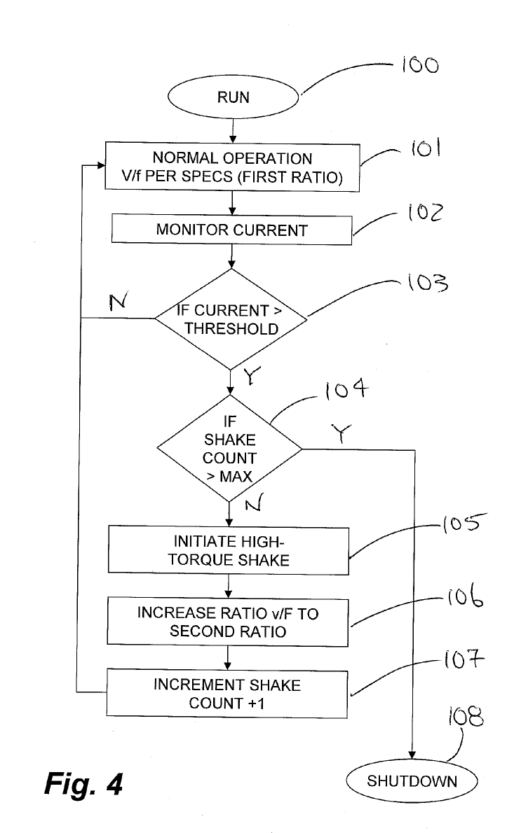

A shown in FIG. 4, the typical operation of the stall detection and response system is to run the motor 11 at Block 100 which might include starting the motor or merely have the motor running in normal operation. The motor 11 is driving a device such as a pump 12.

The VFD 10 drives the motor 11 and coupled device in normal operation at Block 101 including outputting a first V/f ratio to the motor according to the manufacturer's specifications, whether at full rotational speed (e.g. 120V and 60 Hz) or at some lesser speed (e.g. 85V and 30 Hz).

The stall detection circuit or system 20, usually part of the VFD 10, at Block 102 monitors the current to see if the motor 11 has stalled. The stall detection system 20 monitors for a high current, over the maximum threshold current for that speed, and for an allocated duration. At Block 103, if the current has NOT exceeded the current threshold for more than the permitted duration, then the VFD and stall detection system 20 continue to monitor while normal operation continues. Otherwise, as a stall is detected, the shaking procedure commences.

At Block 104, a counter is checked to see if and how many times a shaking procedure has been performed. If the procedure has been performed for more than a preset number of times—for example 3 or 4 times, then the motor 11 is stopped as it has not been successful in releasing the stall and the VFD 10 and motor 11 are stopped at Block 108 to protect the components. Otherwise, the shaking procedure is initiated at Block 105 and repeated until such time as a pre-set number of attempts have been completed or the stall is resolved.

Shaking is induced at Block 106 by increasing the motor torque beyond the motor's normal curve to induce shaking by increasing the V/f to a second ratio greater than the normal constant first V/f ratio typically employed to adjust speed at constant torque. Shaking is maintained for a preset time, depending on the motor 11 and the device 12 which is the source of the problem. For a small pump 12 one might apply shaking for 5 seconds or so. At Block 107, the shake counter is incremented.

Following the shaking sequence at Block 105, the success of the shaking on the stall is assessed and if successful, would return to Block 101 in which normal first V/f ratios are applied and the current is again monitored for further stalls should they occur again.

1. A method for overcoming a mechanically induced stall in a device rotationally coupled to an AC induction motor comprising:
outputting voltage (V) and frequency (f) to the motor at a first V/f ratio for normal operation of the motor and coupled device;
sensing motor current for establishing a stall situation; and
adjusting the V and f output to the motor to at least a second V/f ratio which is greater than the first ratio to induce shaking in the motor therein for overcoming the mechanically induced stall.

2. The method of claim 1 wherein the at least second V/f ratio is over two times the first V/f ratio.

3. The method of claim 1 wherein the device is pump and the a least second V/f ratio is increased to overcome a mechanically induced stall in the pump.

4. The method of claim 1 wherein after inducing shaking for a pre-determined period of time, further comprising:
adjusting V and f output to about the first V/f ratio, being less than the at least second V/f ratio;
sensing motor current for establishing whether the stall situation has been overcome; and
repeating the steps of adjusting the V and f output between the second V/f ratio and the first V/f ratio for overcoming the mechanically induced stall.

5. The method of claim 4 wherein the steps of adjusting the V and f output between the second V/f ratio and the first V/f ratio and sensing for having overcome a mechanically induced stall are repeated at least two times.

6. Apparatus for overcoming a mechanically induced stall in a device rotationally coupled to an AC induction motor comprising:
a variable frequency drive (VFD) for outputting voltage (V) and frequency (f) to the motor at a first V/f ratio for normal operation of the motor and coupled device;
a stall detection system for sensing motor current and establishing a stall situation; and
a response system for adjusting the V and f output from the VFD to the motor to at least a second V/f ratio which is greater than the first V/f ratio, wherein upon detecting a stall situation, the at least second V/f ratio induces shaking in the motor therein for overcoming the mechanically induced stall.
